(19) United States
(12) Patent Application Publication
(10) Pub. No.: US 2023/0310943 A1
(43) Pub. Date: Oct. 5, 2023

(54) GOLF BALL

(71) Applicant: Sumitomo Rubber Industries, Ltd., Kobe-shi (JP)

(72) Inventors: Takashi KAJIKAWA, Kobe-shi (JP); Mami TANAKA, Kobe-shi (JP); Toshiyuki TARAO, Kobe-shi (JP)

(73) Assignee: Sumitomo Rubber Industries, Ltd., Kobe-shi (JP)

(21) Appl. No.: 18/128,288

(22) Filed: Mar. 30, 2023

(30) Foreign Application Priority Data
Mar. 31, 2022 (JP) 2022-058884

(51) Int. Cl. A63B 37/00; C09D 175/06; C08G 18/42; C08G 18/64; C08G 18/75; C08G 18/10

(52) U.S. Cl. CPC A63B 37/00221; C09D 175/06; C08G 18/4277; C08G 18/6484; C08G 18/755; C08G 18/10; A63B 2209/00; A63B 37/0096

(57) ABSTRACT

An object of the present disclosure is to provide a golf ball which has excellent spin performance on short iron shots to long iron shots while maintaining a flight distance on driver shots and from which stain such as mud or grass juice can be wiped off when the stain is adhered to the golf ball. The present disclosure provides a golf ball comprising a golf ball body and a paint film composed of at least one layer and formed on a surface of the golf ball body, wherein an outermost layer of the paint film includes, as a base resin, a polyurethane obtained by a reaction between a polyisocyanate composition and a polyol composition, and the polyol composition contains, as a polyol component, a polyrotaxane having at least two hydroxyl groups and a polycarbonate diol having a number average molecular weight in a range from 400 to 900.

### FIELD OF THE INVENTION

The present disclosure relates to a golf ball having a paint film.

### DESCRIPTION OF THE RELATED ART

Conventionally, a golf ball has a paint film formed on a surface of a golf ball body. It has been proposed to improve spin performance on approach shots by improving the paint film.

For example, JP 2016-093386 A discloses a golf ball comprising a golf ball body and a paint film formed on a surface of the golf ball body, wherein the paint film is formed from a curing type paint composition containing a base material including a polyrotaxane and a curing agent including a polyisocyanate, the polyrotaxane has a cyclodextrin, a linear molecule piercing through the cyclic structure of the cyclodextrin, and blocking groups located at both terminals of the linear molecule to prevent disassociation of the cyclodextrin, and at least a part of hydroxyl groups of the cyclodextrin is modified with a caprolactone chain via a —O—C₃H₆—O— group.

JP 2021-137298 A discloses a golf ball comprising a golf ball body and a paint film composed of at least one layer and formed on a surface of the golf ball body, wherein at least one layer of the paint film includes, as a base resin, a polyurethane obtained by a reaction between a polyisocyanate composition and a polyol composition, and the polyol composition contains, as a polyol component, a polyrotaxane having at least two hydroxyl groups and a urethane polyol, and an amount of the polyrotaxane having at least two hydroxyl groups in the polyol component is more than 0 mass % and less than 10 mass %,

### SUMMARY OF THE INVENTION

It goes without saying that not only flight distance on driver shots but also accuracy on second shots or third shots are important in scoring a golf. The second shots or third shots are shots directly aiming at the green, and controllability is extremely important for them. However, there is a problem that a golf ball having a great spin rate when being hit with a long iron to a short iron (e.g. #5 iron to #8 iron) that is frequently used for the second shots or third shots has an increased spin rate on driver shots, and thus travels a short flight distance on driver shots.

Further, if a paint film is softened to enhance the spin rate on iron shots, there is a problem that the golf ball is easy to be stained by grass juice or mud. For this reason, improvement on stain resistance is conducted so that the golf ball has less stain such as mud or grass juice adhered thereto. However, the stain resistance is not always enough, and a golf ball surface sometimes has stain adhered thereto. When a golf ball has stain such as mud or grass juice adhered thereto, there is a problem that the stain permeates the golf ball and cannot be cleanly wiped off.

The present disclosure has been made in view of the abovementioned circumstances, and an object of the present disclosure is to provide a golf ball which has excellent spin performance on short iron shots to long iron shots while maintaining a flight distance on driver shots and from which stain such as mud or grass juice can be wiped off when the stain is adhered to the golf ball,

The present disclosure that has solved the above problem provides a golf ball comprising a golf ball body and a paint film composed of at least one layer and formed on a surface of the golf ball body, wherein an outermost layer of the paint film includes, as a base resin, a polyurethane obtained by a reaction between a polyisocyanate composition and a polyol composition, and the polyol composition contains, as a polyol component, a polyrotaxane having at least two hydroxyl groups and a polycarbonate diol having a number average molecular weight in a range from 400 to 900.

According to the present disclosure, a golf ball which has excellent spin performance on short iron shots to long iron shots while maintaining a flight distance on driver shots and from which stain such as mud or grass juice can be wiped off when the stain is adhered to the golf ball, can be provided.

### BRIEF DESCRIPTION OF THE DRAWINGS

FIG. 1 is an illustration figure showing a molecular structure of one example of the polyrotaxane used in the present disclosure;

FIG. 2 is a partially cutaway cross-sectional view showing a golf ball according to one embodiment of the present disclosure;

FIG. 3 is a schematic cross-sectional view illustrating a measuring location of a thickness of a paint film; and

FIG. 4 is a schematic cross-sectional view illustrating a measuring location of a thickness of a paint film.

### DESCRIPTION OF THE PREFERRED EMBODIMENT

The present disclosure that has solved the above problem provides a golf ball comprising a golf ball body and a paint film composed of at least one layer and formed on a surface of the golf ball body, wherein an outermost layer of the paint film includes, as a base resin, a polyurethane obtained by a reaction between a polyisocyanate composition and a polyol composition, and the polyol composition contains, as a polyol component, a polyrotaxane having at least two hydroxyl groups and a polycarbonate diol having a number average molecular weight in a range from 400 to 900.

The 10% elastic modulus of the outermost layer of the paint film is preferably 1 kgf/cm² (0.10 MPa) or more, more preferably 3 kgf/cm² (0.29 MPa) or more, and even more preferably 10 kgf/cm² (0.98 MPa) or more, and is preferably 100 kgf/cm² (9.8 MPa) or less, more preferably 75 kgf/cm² (7.4 MPa) or less, and even more preferably 60 kgf/cm² (5.9 MPa) or less. If the 10% elastic modulus of the outermost layer of the paint film is 1 kgf/cm² or more; the paint film has a low tackiness and thus is hard to be stained, and if the 10% elastic modulus of the outermost layer of the paint film is 100 kgf/cm² or less, the paint film has a greater static friction force and thus the spin rate on approach shots from the rough (under a condition that there is grass between the golf ball and the club face) increases.

The thickness of the outermost layer of the paint film is preferably 5 μm or more, more preferably 7 μm or more, and even more preferably 9 μm or more, and is preferably 40 μm or less, more preferably 30 μm or less, and even more preferably 20 μm or less. If the thickness of the outermost layer of the paint film falls within the above range, the paint film has better appearance, and the golf ball has better abrasion resistance and approach performance.

In case that the paint film of the golf ball according to the present disclosure has a multi-layered structure, the total thickness of the paint film is preferably 5 μm or more, more preferably 7 μm or more, and even more preferably 9 μm or more, and is preferably 50 μm or less, more preferably 45 μm or less, and even more preferably 40 μm or less. If the thickness is 5 μm or more, the spin rate on approach shots increases, and if the thickness is 50 μm or less, the spin rate on driver shots is suppressed.

The 10% elastic modulus of the paint film layer is controlled by the resin component of the paint film, the amount thereof or the like. In case that the paint film has a multi-layered structure, the layer of the paint film positioned on the outermost side is the outermost layer of the paint film. In case that the paint film is single-layered, the single-layered paint film is the outermost layer of the paint film.

### (Polyurethane)

In the golf ball according to the present disclosure, the outermost layer of the paint film includes, as a base resin, a polyurethane obtained by a reaction between a polyisocyanate composition and a polyol composition. The polyurethane is preferably a polymer having a plurality of urethane bonds in the main chain. The amount of the polyurethane in the base resin is preferably 50 mass % or more, more preferably 79 mass % or more, and even more preferably 90 mass % or more. It is also preferable that the base resin essentially consists of the polyurethane.

The outermost layer of the paint film is preferably formed from a paint containing the polyol composition and the polyisocyanate composition. Examples of the paint include a so-called curing type urethane paint having the polyol composition as a base material, and the polyisocyanate composition as a curing agent.

### (Polyol Composition)

The polyol composition used in the present disclosure preferably contains, as a polyol component, a polyrotaxane having at least two hydroxyl groups and a polycarbonate diol having a number average molecular weight in a range from 400 to 900. Herein, the polyol is, for example, a compound having two or more hydroxyl groups in the molecule.

The number average molecular weight of the polycarbonate diol is preferably 400 or more, more preferably 450 or more, and even more preferably 500 or more, and is preferably 900 or less, more preferably 850 or less, and even more preferably 800 or less. If the number average molecular weight of the polycarbonate diol is 400 or more, the distance between the crosslinking points in the paint film is long, the paint film is soft, and thus the spin performance is enhanced. If the number average molecular weight of the polycarbonate diol is 900 or less, the distance between the crosslinking points in the paint film is not excessively long, and thus the paint film has better stain resistance. It is noted that the number average molecular weight of the polycarbonate diol can be measured, for example, by gel permeation chromatography (GPO), using polystyrene as a standard material, tetrahydrofuran as an eluate, and an organic solvent system GPO column (e.g. “Shodex (registered trademark) KF series” available from Showa Denko K.K.) as a column.

The polycarbonate diol is preferably a liquid polycarbonate diol. Herein, “liquid polycarbonate diol” means the polycarbonate diol is a viscous liquid at a temperature of 25° C. If the liquid polycarbonate diol is used, the paint film is softer and thus the spin performance is further enhanced. The viscosity of the liquid polycarbonate diol preferably ranges from 50 mPa·s/50° C. to 100,000 mPa·s/50° C., ranges from 30 mPa·s/60° C. to 50,000 mPa·s/60° C., or ranges from 10 mPa·s/70° C. to 20,000 mPa·s/70° C. The viscosity can be measured, for example, with B type viscometer and rotor HM2.

The viscosity of the liquid polycarbonate diol is preferably 50 mPa·s or more/50° C. and 100,000 mPa·s or less/50° C., more preferably 100 mPa·s or more/50° C. and 5,000 mPa·s or less/50° C., and eve more preferably 200 mPa·s or more/50° C. and 2,000 mPa·s or less/50° C.

### (Polyrotaxane Having at Least Two Hydroxyl Groups)

In the present disclosure, a “rotaxane” means a molecule having a structure having at least one cyclic molecule and an axial molecule piercing through the cavity of the cyclic molecule, regardless of whether a blocking structure to prevent disassociation of the cyclic molecule from the axial molecule exists on the axial molecule or not. A “rotaxane” having the axial molecule piercing through two or more cyclic molecules is sometimes referred to as a “polyrotaxane”. The “polyrotaxane” having the axial molecule piercing through two or more cyclic molecules is included in the “rotaxane” having the axial molecule piercing through at least one cyclic molecule.

The polyrotaxane used in the present disclosure preferably has at least two hydroxyl groups. This is because such polyrotaxane reacts with the polyisocyanate to form the polyurethane.

The polyrotaxane having at least two hydroxyl groups preferably has a cyclodextrin, a linear molecule piercing through the cyclic structure of the cyclodextrin, and blocking groups located at both terminals of the linear molecule to prevent disassociation of the cyclodextrin, wherein at least a part of hydroxyl groups of the cyclodextrin is modified with a caprolactone chain via a —O—-C₃H₆—O— group. The hydroxyl group included in the cyclodextrin of the polyrotaxane and the isocyanate group included in the polyisocyanate react to form the polyurethane.

The polyrotaxane is viscoelastic, since the cyclodextrin molecule is movable along the linear molecule that penetrates the cyclodextrin in a skewering manner (pulley effect). Even if a tension is applied to the polyrotaxane, the tension can be uniformly dispersed due to the pulley effect. Thus, the polyrotaxane provides an excellent property that a crack or flaw very hardly occurs, unlike a conventional crosslinked polymer.

The cyclodextrin is a general term for an oligosaccharide having a cyclic structure. The cyclodextrin is, for example, a molecule having 6 to 8 D-glucopyranose residues being linked in a cyclic shape via an α-1,4-glucoside bond. Examples of the cyclodextrin include α-cyclodextrin (number of glucose units: 6), β-cyclodextrin (number of glucose units: 7), and γ-cyclodextrin (number of glucose units: 8), and α-cyclodextrin is preferable. As the cyclodextrin, one type may be used solely, and two or more types may be used in combination.

The linear molecule is not particularly limited, as long as it is a linear molecule capable of piercing through the cyclic structure of the cyclodextrin so that the cyclic structure of the cyclodextrin is movable along and rotatable around the linear molecule. Examples of the linear molecule include polyalkylene, polyester, polyether, and polyacrylic acid. Among them, polyether is preferable, polyethylene glycol is particularly preferable. Polyethylene glycol has less steric hindrance, and thus can easily pierce through the cyclic structure of the cyclodextrin.

The weight average molecular weight of the linear molecule is preferably 5,000 or more, more preferably 6,000 or more, and is preferably 100,000 or less, more preferably 80,000 or less.

The linear molecule preferably has a functional group at both terminals thereof. When the linear molecule has the functional group, the linear molecule can easily react with the blocking group. Examples of the functional group include a hydroxyl group, a carboxyl group, an amino group, and a thiol group.

The blocking group is not particularly limited, as long as it is located at both terminals of the linear molecule to prevent the cyclodextrin from disassociating from the linear molecule. Examples of the method for preventing the disassociation include a method of using a bulky blocking group to physically prevent the disassociation, and a method of using an ionic blocking group to electrostatically prevent the disassociation. Examples of the bulky blocking group include a cyclodextrin and an adamantyl group. The number of the cyclodextrins which the linear molecule pierces through preferably ranges from 0.06 to 0.61, more preferably ranges from 0.11 to 0.48, even more preferably ranges from 0.24 to 0.41, if the maximum number of the cyclodextrins which the linear molecule pierces through is deemed as 1. This is because if the number of the cyclodextrins is less than 0.06, the pulley effect may not be exerted, and if the number of the cyclodextrins exceeds 0.61, the cyclodextrins are very densely located, so that the movability of the cyclodextrin may decrease.

The polyrotaxane is preferably a polyrotaxane having at least a part of hydroxyl groups of the cyclodextrin being modified with a caprolactone chain. Modifying with the caprolactone chain alleviates the steric hindrance between the polyrotaxane and the polyisocyanate, and thus enhances the reaction efficiency with the polyisocyanate.

As the above modification, for example, the hydroxyl groups of the cyclodextrin are treated with propylene oxide to hydroxylpropylate the cyclodextrin, and then ε-caprolactone is added to perform ring-opening polymerization. As a result of this modification, the caprolactone chain —(CO(CH₂)₅O)nH (n is a natural number ranging from 1 to 100) is linked to the exterior side of the cyclic structure of the cyclodextrin via —O—C₃H₆—O— group. The above “n” represents the degree of polymerization, and is preferably a natural number ranging from 1 to 100, more preferably a natural number ranging from 2 to 70, even more preferably a natural number ranging from 3 to 40. At another terminal of the caprolactone chain, a hydroxyl group is formed through the ring-opening polymerization. The terminal hydroxyl group of the caprolactone chain can react with the polyisocyanate.

The ratio of the hydroxyl groups modified with the caprolactone chain to all the hydroxyl groups (100 mole %) included in the cyclodextrin before the modification is preferably 2 mole % or more, more preferably 5 mole % or more, even more preferably 10 mole % or more. If the ratio of the hydroxyl groups modified with the caprolactone chain falls within the above range, the polyrotaxane has greater hydrophobicity and thus has a higher reactivity with the polyisocyanate.

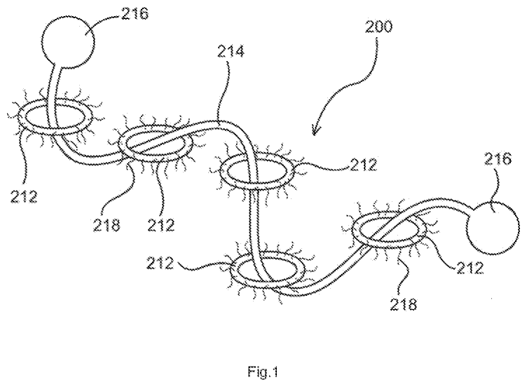

FIG. 1 is an illustration figure showing a molecular structure of one example of the polyrotaxane used in the present disclosure. A polyrotaxane 200 has a cyclodextrin 212, a linear molecule 214 piercing through the cyclic structure of the cyclodextrin 212, and blocking groups 216 located at both terminals of the linear molecule 214 to prevent disassociation of the cyclodextrin 212, and a caprolactone chain 218 is linked to the exterior side of the cyclic structure of the cyclodextrin 212 via —O—C₃H₆—O— group (not shown).

The hydroxyl value of the polyrotaxane is preferably 10 mg KOH/g or more, more preferably 15 mg KOH/g or more, even more preferably 20 mg KOH/g or more, and is preferably 400 mg KOH/g or less, more preferably 300 mg KOH/g or less, even more preferably 220 mg KOH/g or less, particularly preferably 180 mg KOH/g or less. If the hydroxyl value of the polyrotaxane falls within the above range, the polyrotaxane has a higher reactivity with the polyisocyanate, and thus the paint film has better durability.

The total molecular weight of the polyrotaxane is preferably 30,000 or more, more preferably 40,000 or more, even more preferably 50,000 or more, and is preferably 3,000,000 or less, more preferably 2,500,000 or less, even more preferably 2,000,000 or less, in a weight average molecular weight. If the total weight average molecular weight is 30,000 or more, the paint film has sufficient strength, and if the total weight average molecular weight is 3,000,000 or less, the paint film has sufficient flexibility and thus the golf ball has enhanced approach performance. It is noted that the weight average molecular weight of the polyrotaxane may be measured, for example, by gel permeation chromatography (GPO) using polystyrene as a standard substance, tetrahydrofuran as an eluant, and an organic solvent system GPO column (e.g., “Shodex (registered trademark) KF series” available from Showa Denko K.K.) as a column.

Specific examples of the polyrotaxane modified with the polycaprolactone chain include SeRM super polymer SH₃₄₀₀P, SH₂₄₀₀P, and SH₁₃₀₀P available from Advanced Softmaterials Inc.

The polyol component of the polyol composition used in the present disclosure preferably consists of the polycarbonate diol having the number average molecular weight in the range from 400 to 900 and the polyrotaxane having at least two hydroxyl groups.

In another preferable embodiment, the polyol composition used in the present disclosure may further contain a second polyol as the polyol component in addition to the polycarbonate diol having the number average molecular weight in the range from 400 to 900 and the polyrotaxane having at least two hydroxyl groups. Examples of the second polyol include a low molecular weight polyol having a molecular weight of less than 500, and a high molecular weight polyol having a number average molecular weight of 500 or more.

Examples of the low molecular weight polyol include a diol such as ethylene glycol, diethylene glycol, triethylene glycol, 1,3-butanediol, 1,4-butanediol, neopentyl glycol and 1,6-hexanediol; and a triol such as glycerin, trimethylolpropane, and hexanetriol. Examples of the high molecular weight polyol include a polyether polyol, a polyester polyol, a polycaprolactone polyol, an acrylic polyol, and a urethane polyol. Examples of the polyether polyol include polyoxyethylene glycol (PEG), polyoxypropylene glycol (PPG), and polyoxytetramethylene glycol (PTMG). Examples of the polyester polyol include polyethylene adipate (PEA), polybutylene adipate (PBA), and polyhexamethylene adipate (PHMA). Examples of the polycaprolactone polyol include poly-ε-caprolactone (PCL).

The polyol composition used in the present disclosure preferably contains a hydroxy group modified vinyl chloride-vinyl acetate copolymer as a second polyol component. The hydroxy group modified vinyl chloride-vinyl acetate copolymer adjusts the adhesion of the paint film while maintaining the scuff resistance of the paint film. The hydroxy group modified vinyl chloride-vinyl acetate copolymer is obtained, for example, by a method of copolymerizing vinyl chloride, vinyl acetate, and a monomer having a hydroxy group (e.g., polyvinyl alcohol, hydroxyalkyl acrylate); and a method of partially or completely saponifying a vinyl chloride-vinyl acetate copolymer.

The amount of the vinyl chloride component in the hydroxy group modified vinyl chloride-vinyl acetate copolymer is preferably 1 mass % or more, more preferably mass % or more, and even more preferably 50 mass % or more, and is preferably 99 mass % or less, more preferably 95 mass % or less, Specific examples of the hydroxy group modified vinyl chloride-vinyl acetate copolymer include Solbin (registered trademark) A, Solbin AL, and Solbin TA3 available from Nissin Chemical Industry Co., Ltd.

The amount of the polycarbonate dial having the number average molecular weight in the range from 400 to 900 in the polyol component contained in the polyol composition is preferably more than 90 mass %, more preferably 92 mass % or more, and even more preferably 94 mass % or more, and is preferably less than 100 mass %, more preferably 99 mass % or less, and even more preferably 98 mass % or less.

The amount of the polyrotaxane having at least two hydroxyl groups in the polyol component contained in the polyol composition is preferably more than 0 mass %, more preferably 1 mass % or more, and even more preferably 2 mass % or more, and is preferably less than 10 mass %, more preferably 8 mass % or less, and even more preferably 6 mass % or less. If the amount of the polyrotaxane falls within the above range, the stain resistance and the leveling property are better.

It is noted that the amount of each components included as the polyol is appropriately determined in the above-described range such that the total amount of these components becomes 100%.

### (Polyisocyanate Composition)

Examples of the polyisocyanate component of the polyisocyanate composition used in the present disclosure include a compound having at least two isocyanate groups, Examples of the polyisocyanate include an aromatic polyisocyanate such as 2,4-tolylene diisocyanate, 2,6-tolylene diisocyanate, a mixture of 2,4-tolylene diisocyanate and 2,6-tolylene diisocyanate (TDI), 4,4′-diphenylmethane diisocyanate (MDI), 1,5-naphthylene diisocyanate (NDI), 3,3′-bitolylene-4,4′-diisocyanate (TODI), xylylene diisocyanate (XDI), tetramethylxylylene diisocyanate (TMXDI), and paraphenylene diisocyanate (PPDI); an alicyclic polyisocyanate or aliphatic polyisocyanate such as 4,4′-dicyclohexylmethane diisocyanate (H₁₂MDI), hydrogenated xylylene diisocyanate (H₆XDI), hexamethylene diisocyanate (HDI), isophorone diisocyanate (IPDI), and norbornene diisocyanate (NBDI); and derivatives of these polyisocyanates. In the present disclosure, two or more of the polyisocyanates may be used in combination.

Examples of the derivative of the polyisocyanate include an adduct-modified product obtained by a reaction between a diisocyanate and a polyhydric alcohol; an isocyanurate-modified product of a diisocyanate; a biuret-modified product; and an allophanate-modified product, and the one from which free diisocyanate has been removed is more preferable. The polyisocyanate composition preferably contains, as a polyisocyanate component, at least one member selected from the group consisting of an isocyanurate-modified product of hexamethylene diisocyanate, an adduct-modified product of hexamethylene diisocyanate, a biuret-modified product of hexamethylene diisocyanate, and an isocyanurate-modified product of isophorone diisocyanate.

The biuret-modified product is, for example, a biuret-modified product in which a diisocyanate is trimerized (the following formula (1)). In the formula (1), R represents a residue where isocyanate groups are removed from the diisocyanate. The biuret-modified product is preferably a timer of hexamethylene diisocyanate.

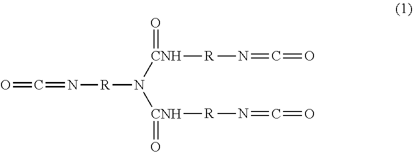

Examples of the isocyanurate-modified product include a trimer of diisocyanate represented by the following formula (2). In the formula (2), R represents a residue where isocyanate groups are removed from the diisocyanate. Examples of the isocyanurate-modified product include an isocyanurate-modified product of hexamethylene diisocyanate and an isocyanurate-modified product of isophorone diisocyanate, and a trimer of hexamethylene diisocyanate or a trimer of isophorone diisocyanate is preferable.

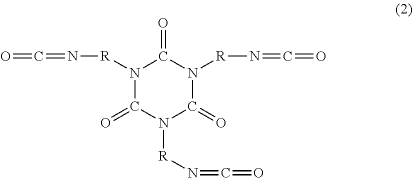

The adduct-modified product is a polyisocyanate obtained by a reaction between a diisocyanate and a polyhydric alcohol. The polyhydric alcohol is preferably a low molecular weight triol such as trimethylolpropane or glycerin. The adduct-modified product is preferably, for example, a triisocyanate (the following formula (3)) obtained by a reaction between a diisocyanate and trimethylolpropane, and a triisocyanate (the following formula (4)) obtained by a reaction between a diisocyanate and glycerin. In the formulae (3) and (4), R represents a residue where isocyanate groups are removed from the diisocyanate.

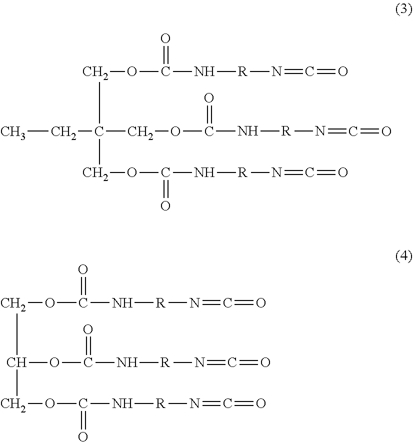

The adduct-modified product is preferably, for example, an adduct-modified product of hexamethylene diisocyanate, more preferably a triisocyanate obtained by a reaction between hexamethylene diisocyanate and trimethylolpropane, and a triisocyanate obtained by a reaction between hexamethylene diisocyanate and glycerin.

The allophanate product is, for example, a triisocyanate obtained by further reacting a diisocyanate with a urethane bond formed by a reaction between a diisocyanate and a low molecular weight dial.

### (Adduct-Modified Product)

In a preferable embodiment of the present disclosure, the polyisocyanate component preferably includes the adduct-modified product, more preferably the adduct-modified product of hexamethylene diisocyanate (preferably a trimer). In case that the adduct-modified product of hexamethylene diisocyanate is used, the amount of the adduct-modified product of hexamethylene diisocyanate in the polyisocyanate component is preferably 10 mass % or more, more preferably 20 mass % or more, and even more preferably 30 mass % or more. It is also preferable that the polyisocyanate component consists of the adduct-modified product of hexamethylene diisocyanate.

### (Isocyanurate-Modified Product)

In another preferable embodiment of the present disclosure, the polyisocyanate component preferably includes the isocyanurate-modified product, more preferably the isocyanurate-modified product of hexamethylene diisocyanate (preferably a timer) or the isocyanurate-modified product of isophorone diisocyanate (preferably a timer), and even more preferably a combination of the isocyanurate-modified product of hexamethylene diisocyanate (preferably a trimer) and the isocyanurate-modified product of isophorone diisocyanate (preferably a trimer). In case that the isocyanurate-modified product of hexamethylene diisocyanate and the isocyanurate-modified product of isophorone diisocyanate are used in combination, the mass ratio (isocyanurate-modified product of hexamethylene diisocyanate isocyanurate-modified product of isophorone diisocyanate) of the isocyanurate-modified product of hexamethylene diisocyanate to the isocyanurate-modified product of isophorone diisocyanate is preferably 0,1 or more, more preferably 0.2 or more, and even more preferably 0.3 or more, and is preferably 9 or less, more preferably 4 or less, and even more preferably 3 or less. If the mass ratio falls within the above range, the spin rate on approach shots under a condition that there is grass between the golf ball and the club face further increases.

### (Adduct-Modified Product and Isocyanurate-Modified Product)

In another preferable embodiment of the present disclosure, the polyisocyanate component preferably includes a combination of the adduct-modified product and the isocyanurate-modified product, more preferably a combination of the adduct-modified product of hexamethylene diisocyanate (preferably a trimer) and the isocyanurate-modified product of hexamethylene diisocyanate (preferably a trimer), or a combination of the adduct-modified product of hexamethylene diisocyanate (preferably a trimer) and the isocyanurate-modified product of isophorone diisocyanate (preferably a trimer). In this case, the mass ratio (adduct-modified product/isocyanurate-modified product) of the adduct-modified product to the isocyanurate-modified product is preferably 0.1 or more, more preferably 0.3 or more, and even more preferably 0.4 or more, and is preferably 9 or less, more preferably 5 or less, and even more preferably 4 or less. If the mass ratio falls within the above range, the spin performance on approach shots from the rough increases.

### (HDI Adduct-Modified Product and HDI Isocyanurate-Modified Product)

In another preferable embodiment of the present disclosure, when the adduct-modified product of hexamethylene diisocyanate and the isocyanurate-modified product of hexamethylene diisocyanate are used as the polyisocyanate component, the total amount of the adduct-modified product of hexamethylene diisocyanate and the isocyanurate-modified product of hexamethylene diisocyanate in the polyisocyanate component is preferably 70 mass % or more, more preferably 80 mass % or more, and even more preferably 90 mass % or more. it is also preferable that the polyisocyanate component consists of the adduct-modified product of hexamethylene diisocyanate and the isocyanurate-modified product of hexamethylene diisocyanate.

### (HDI Isocyanurate-Modified Product and IPDI Isocyanurate-Modified Product)

In another preferable embodiment of the present disclosure, when the isocyanurate-modified product of hexamethylene diisocyanate and the isocyanurate-modified product of isophorone diisocyanate are used as the polyisocyanate component, the total amount of the isocyanurate-modified product of hexamethylene diisocyanate and the isocyanurate-modified product of isophorone diisocyanate in the polyisocyanate component is preferably 70 mass % or more, more preferably 80 mass % or more, and even more preferably 90 mass % or more. It is also preferable that the polyisocyanate component consists of the isocyanurate-modified product of hexamethylene diisocyanate and the isocyanurate-modified product of isophorone diisocyanate.

### (HDI Adduct-Modified Product and IPDI Isocyanurate-Modified Product)

In another preferable embodiment of the present disclosure, when the adduct-modified product of hexamethylene diisocyanate and the isocyanurate-modified product of isophorone diisocyanate are used as the polyisocyanate component, the total amount of the adduct-modified product of hexamethylene diisocyanate and the isocyanurate-modified product of isophorone diisocyanate in the polyisocyanate component is preferably 70 mass % or more, more preferably 80 mass % or more, and even more preferably 90 mass % or more. It is also preferable that the polyisocyanate component consists of the adduct-modified product of hexamethylene diisocyanate and the isocyanurate-modified product of isophorone diisocyanate.

The amount of the isocyanate group (NCO %) included in the polyisocyanate component is preferably 0.5 mass % or more, more preferably 1.0 mass % or more, and even more preferably 2.0 mass % or more, and is preferably 45 mass % or less, more preferably 40 mass % or less, and even more preferably 35 mass % or less. It is noted that the amount of the isocyanate group (NCO %) included in the polyisocyanate component can be represented by the following expression.

NCO (%)=100×[mole number of the isocyanate group included in the polyisocyanate×42 (molecular weight of NCO)]/[total mass (g) of the polyisocyanate]

Specific examples of the polyisocyanate component include Burnock (registered trademark) D-800, Burnock DN-950, and Burnock DN-955 available from DIC corporation; Desmodur (registered trademark) N75MPA/X, Desmodur N3300, Desmodur N3390, Desmodur L75 (C), and Sumidur (registered trademark) E21-1 available from Sumika Bayer Urethane Co., Ltd.; Coronate (registered trademark) HX, Coronate HK, Coronate HL, and Coronate EH available from Tosoh Corporation; Duranate (registered trademark) 24A-100, Duranate 21S-75E, Duranate TPA-100, Durante TKA-100, and Durante 24A-90CX available from Asahi Kasei Chemicals Corporation; and VESTANAT (registered trademark) T1890 available from Degussa.

In the curing reaction of the curing type paint composition, the molar ratio (NCO group/OH group) of the isocyanate group (NCO group) included in the polyisocyanate composition to the hydroxyl group (OH group) included in the polyol composition is preferably 1.0 or more, more preferably 1.1 or more; and even more preferably 1.2 or more. If the molar ratio (NCO group/OH group) is less than 1.0, the curing reaction is not sufficient, and if the molar ratio (NCO group/OH group) is excessively great, the amount of the isocyanate group becomes excessive, and thus the obtained paint film may become hard and fragile, and the appearance thereof may deteriorate. For this reason, the molar ratio (NCO group/OH group) is preferably 2.0 or less, more preferably 1.8 or less, and even more preferably 1.6 or less. It is noted that the reason why the appearance of the obtained paint film deteriorates if the amount of the isocyanate group is excessive in the paint is considered that an excessive amount of the isocyanate group may promote a reaction between the moisture in the air and the isocyanate group, thereby generating a lot of carbon dioxide gas.

The paint may be either a waterborne paint mainly containing water as a dispersion medium or a solvent-based paint containing an organic solvent as a dispersion medium, and the solvent-based paint is preferable. In case of the solvent-based paint, preferable examples of the solvent include toluene, isopropyl alcohol, xylene, methyl ethyl ketone, methyl ethyl isobutyl ketone, ethylene glycol monomethyl ether, ethylbenzene, propylene glycol monomethyl ether, isobutyl alcohol, and ethyl acetate. It is noted that the solvent may be blended in either the polyol composition or the polyisocyanate composition. From the viewpoint of uniformly performing the curing reaction, the solvent is preferably blended in each of the polyol composition and the polyisocyanate composition.

The paint preferably further includes a modified silicone. If the modified silicone is included as a leveling agent, unevenness of the coated surface can be reduced, and thus a smooth coated surface can be formed on the surface of the golf ball. Examples of the modified silicone include a modified silicone having an organic group being introduced to a side chain or a terminal of a polysiloxane skeleton, a polysiloxane block copolymer obtained by copolymerizing a polyether block and/or a polycaprolactone block, etc. with a polysiloxane block, and a modified silicone having an organic group being introduced to a side chain or a terminal of the polysiloxane block copolymer. The polysiloxane skeleton or the polysiloxane block is preferably linear, and examples thereof include dimethyl polysiloxane, methylphenyl polysiloxane, and methyl hydrogen polysiloxane. Examples of the organic group include an amino group, epoxy group, mercapto group, and carbinol group. In the present disclosure, as the modified silicone oil, a polydimethylsiloxane-polycaprolactone block copolymer is preferably used, and a terminal carbinol-modified polydimethylsiloxane-polycaprolactone block copolymer is more preferably used. This is because these block copolymers have excellent compatibility with the caprolactone-modified polyrotaxane. Specific examples of the modified silicone used in the present disclosure include DBL-031, DBE-224, and DCE-7521 available from Gelest, Inc.

The modified silicone remains in the paint film formed from the paint composition. The amount of the modified silicone in the paint film and curing type paint composition is preferably 0.01 part by mass or more, more preferably 0.05 part by mass or more, and is preferably 10 parts by mass or less, more preferably 5 parts by mass or less, with respect to 100 parts by mass of the base resin component constituting the layer of the paint film.

A conventionally known catalyst can be employed in the curing reaction. Examples of the catalyst include a monoamine such as triethyl amine and N,N-dimethylcyclohexylamine; a polyamine such as N,N,N′,N′-tetramethylethylene diamine and N,N,N′,N″, N″-pentamethyldiethylene triamine; a cyclic diamine such as 1,8-diazabicyclo[5.4.0]-7-undecene (DBU) and triethylene diamine; a tin catalyst such as dibutyl tin dilaurate and dibutyl tin diacetate. These catalysts may be used solely, or two or more of the catalysts may be used in combination. Among them, the tin catalyst such as dibutyl tin dilaurate and dibutyl tin diacetate is preferable, dibutyl tin dilaurate is particularly preferable.

The paint film may further include additives that may be generally included in a paint for a golf ball, such as an ultraviolet absorber, an antioxidant, a light stabilizer, a fluorescent brightener, an anti-blocking agent, a leveling agent, a slip agent, and a viscosity modifier, where necessary.

In the case that the paint film has a multi-layered structure, examples of the base resin constituting the layer of the paint film other than the outmost layer of the paint film include a polyurethane, an epoxy resin, an acrylic resin, a vinyl acetate resin, and a polyester resin. Among them, polyurethane is preferable. In addition, as the base resin constituting the layer of the paint film other than the outmost layer of the paint film, the above-described polyurethane used in the outmost layer of the paint film may also be used.

### (Golf Ball)

The golf ball according to the present disclosure is not particularly limited, as long as it comprises a golf ball body and a paint film composed of at least one layer and formed on a surface of the golf ball body. The construction of the golf ball body is not particularly limited, and may be a one-piece golf ball, a two-piece golf ball, a multi-piece golf ball composed of three or more pieces, or a wound golf ball. The present disclosure can be applied appropriately to any one of the above golf ball bodies.

### (Core)

A one-piece golf ball body, and a core used in a wound golf ball, two-piece golf ball and multi-piece golf ball will be explained.

The one-piece golf ball body and core are formed from a conventional rubber composition (hereinafter sometimes simply referred to as “core rubber composition”). For example, the one-piece golf ball body and core can be molded by heat pressing a rubber composition containing a base rubber, a co-crosslinking agent and a crosslinking initiator.

As the base rubber, particularly preferred is a high-cis polybutadiene having a cis bond in an amount of 40 mass % or more, preferably 70 mass % or more, and more preferably 90 mass % or more in view of its superior resilience. As the co-crosslinking agent, an α,β-unsaturated carboxylic acid having 3 to 8 carbon atoms or a metal salt thereof is preferable, and a metal salt of acrylic acid or a metal salt of methacrylic acid is more preferable. As the metal constituting the metal salt, zinc, magnesium, calcium, aluminum or sodium is preferable, and zinc is more preferable. The amount of the co-crosslinking agent is preferably 20 parts by mass or more and 50 parts by mass or less with respect to 100 parts by mass of the base rubber. In case that the α,β-unsaturated carboxylic acid having 3 to 8 carbon atoms is used as the co-crosslinking agent, a metal compound (e.g. magnesium oxide) is preferably added. As the crosslinking initiator, an organic peroxide is preferably used. Specific examples of the organic peroxide include dicumyl peroxide, 1,1-bis(t-butylperoxy)-3,3,5-trimethylcyclohexane, 2,5-dimethyl-2,5-di(t-butylperoxy) hexane, and di-t-butyl peroxide. Among them, dicumyl peroxide is preferably used. The amount of the crosslinking initiator is preferably 0.2 part by mass or more, more preferably 0.3 part by mass or more, and is preferably 3 parts by mass or less, more preferably 2 parts by mass or less, with respect to 100 parts by mass of the base rubber.

In addition, the core rubber composition may further contain an organic sulfur compound. As the organic sulfur compound, diphenyl disulfides (e.g. diphenyl disulfide, bis(pentabromophenyl) disulfide), thiophenols or thionaphthols (e.g. 2-thionaphthol) are preferably used. The amount of the organic sulfur compound is preferably 0.1 part by mass or more, more preferably 0.3 part by mass or more, and is preferably 5.0 parts by mass or less, more preferably 3.0 parts by mass or less, with respect to 100 parts by mass of the base rubber. The core rubber composition may further contain a carboxylic acid and/or a salt thereof. As the carboxylic acid and/or the salt thereof, a carboxylic acid having 1 to 30 carbon atoms and/or a salt thereof is preferable. As the carboxylic acid, any one of an aliphatic carboxylic acid and an aromatic carboxylic acid (such as benzoic acid) may be used. The amount of the carboxylic acid and/or the salt thereof is preferably 1 part by mass or more and 40 parts by mass or less with respect to 100 parts by mass of the base rubber.

The core rubber composition may further contain a weight adjusting agent such as zinc oxide and barium sulfate, an antioxidant, a colored powder, or the like in addition to the base rubber, the co-crosslinking agent, the crosslinking initiator, and the organic sulfur compound. The molding conditions for heat pressing the core rubber composition may be determined appropriately depending on the rubber composition. Generally, the heat pressing is preferably carried out at a temperature in a range from 130° C. to 200° C. for 10 to 60 minutes, or carried out in a two-step heating of heating at a temperature in a range from 130° C. to 150 00 for 20 to 40 minutes followed by heating at a temperature in a range from 160° C. to 180° C. for 5 to 15 minutes.

### (Cover)

The golf ball body preferably comprises a core and a cover covering the core. In this case, the hardness of the cover is preferably 60 or less, more preferably 55 or less, even more preferably 50 or less, and most preferably 45 or less in Shore hardness. If the hardness of the cover is 60 or less in Shore D hardness, the spin rate further increases. The hardness of the cover is not particularly limited, and is preferably 10 or more, more preferably 15 or more, and even more preferably 20 or more in Shore D hardness. The hardness of the cover is a slab hardness of the cover composition molded into a sheet shape.

The thickness of the cover is preferably 0.1 mm or more, more preferably 0.2 mm or more, and even more preferably 0.3 mm or more, and is preferably 1.0 mm or less, more preferably 0.9 mm or less, and even more preferably 0.8 mm or less. If the thickness of the cover is 0.1 mm or more, the shot feeling of the golf ball is better, and if the thickness of the cover is 1.0 mm or less, the resilience of the golf ball is maintained.

The resin component constituting the cover is not particularly limited, and examples thereof include various resins such as an ionomer resin, a polyester resin, a urethane resin and a polyamide resin; a thermoplastic polyamide elastomer having a trade name of “Pebax (registered trademark) (e.g. “Pebax 2533”)” available from Arkema Inc.; a thermoplastic polyester elastomer having a trade name of “Hytrel (registered trademark) (e.g. “Hytrel 3548” and “Hytrel 4047”)” available from Du Pont-Toray Co., Ltd.; a thermoplastic polyurethane elastomer having a trade name of “Elastollan (registered trademark) (e.g. “Elastollan XNY82A” and “Elastollan XNY97A”)” available from BASF Japan Ltd.; and a thermoplastic styrene elastomer having a trade name of “TEFABLOC” or thermoplastic polyester elastomer available from Mitsubishi Chemical Corporation. These cover materials may be used solely, or two or more of these cover materials may be used in combination.

Among them, the resin component constituting the cover is preferably the polyurethane or the ionomer resin, particularly preferably the polyurethane. When the resin component constituting the cover includes the polyurethane, the amount of the polyurethane in the resin component is preferably 50 mass % or more, more preferably 70 mass % or more, and even more preferably 90 mass % or more. When the resin component constituting the cover includes the ionomer resin, the amount of the ionomer resin in the resin component is preferably 50 mass % or more, more preferably 70 mass % or more, and even more preferably 90 mass % or more.

The polyurethane may be either a thermoplastic polyurethane or a thermosetting polyurethane. The thermoplastic polyurethane is a polyurethane exhibiting plasticity by heating and generally means a polyurethane having a linear chain structure of a high molecular weight to a certain extent. On the other hand, thermosetting polyurethane (two-component curing type polyurethane) is a polyurethane obtained by polymerization through a reaction between a low molecular weight urethane prepolymer and a curing agent (chain extender) when molding the cover. The thermosetting polyurethane includes a polyurethane having a linear chain structure, or a polyurethane having a three-dimensional crosslinked structure depending on the number of the functional group of the prepolymer or curing agent (chain extender) to be used. The polyurethane is preferably thermoplastic elastomer.

The cover may contain a pigment component such as a white pigment (e.g. titanium oxide), a blue pigment and a red pigment, a weight adjusting agent such as calcium carbonate and barium sulfate, a dispersant, an antioxidant, an ultraviolet absorber, a light stabilizer, a fluorescent material or fluorescent brightener; or the like, in addition to the above resin component, as long as they do not impair the performance of the cover.

The embodiment for molding the cover from the cover composition is not particularly limited, and examples thereof include an embodiment comprising injection molding the cover composition directly onto the core; and an embodiment comprising molding the cover composition into hollow shells, covering the core with a plurality of the hollow shells and compression molding the core with a plurality of the hollow sheds (preferably an embodiment comprising molding the cover composition into half hollow-shells, covering the core with two of the half hollow-shells and compression molding the core with two of the half hollow-shells). After the cover is molded, the obtained golf ball body is ejected from the mold, and as necessary, the golf ball body is preferably subjected to surface treatments such as deburring, cleaning, and sandblast. If desired, a mark may be formed.

The total number of dimples formed on the cover is preferably 200 or more and 500 or less. If the total number is less than 200, the dimple effect is hardly obtained. On the other hand, if the total number exceeds 500, the dimple effect is hardly obtained because the size of the respective dimples is small. The shape (shape in a plan view) of dimples includes, for example, without limitation, a circle, a polygonal shape such as a roughly triangular shape, a roughly quadrangular shape, a roughly pentagonal shape, a roughly hexagonal shape, and other irregular shape. The shape of dimples is employed solely or at least two of them may be used in combination.

In the case that the golf ball is a three-piece golf ball, a four-piece golf ball, or a multi-piece golf ball comprising five or more pieces, examples of the material used for the intermediate layer disposed between the core and the outermost cover include a thermoplastic resin such as a polyurethane, an ionomer resin, a polyamide, and polyethylene; a thermoplastic elastomer such as a styrene elastomer, a polyolefin elastomer, a polyurethane elastomer, and a polyester elastomer; and a cured product of a rubber composition. Herein, examples of the ionomer resin include a product obtained by neutralizing, with a metal ion, at least a part of carboxyl groups in a copolymer composed of ethylene and an α,β-unsaturated carboxylic acid; and a product obtained by neutralizing, with a metal ion, at least a part of carboxyl groups in a terpolymer composed of ethylene, an α,β-unsaturated carboxylic acid and an α,β-unsaturated carboxylic acid ester. The intermediate layer may further contain a weight adjusting agent such as barium sulfate and tungsten, an antioxidant, and a pigment. It is noted that the intermediate layer may be referred to as an inner cover layer or an outer core depending on the construction of the golf ball.

### (Formation of Paint Film)

The paint film of the golf ball according to the present disclosure is formed by applying the paint on the surface of the golf ball body. The method of applying the paint is not particularly limited, a conventional method can be adopted, and examples thereof include a spray coating and electrostatic coating.

In the case of the spray coating with an air gun, the polyisocyanate composition and the polyol composition are fed with respective pumps and continuously mixed with a line mixer located in the stream line just before the air gun, and the obtained mixture is air-sprayed. Alternatively, the polyisocyanate composition and the polyol composition are air-sprayed respectively with an air spray system provided with a device for controlling the mixing ratio thereof. The paint application may be conducted by spraying the paint one time or overspraying the paint multiple times.

The paint applied on the golf ball body is dried, for example, at a temperature in a range of from 30° C. to 70° C. for 1 hour to 24 hours, to form the paint film.

The golf ball according to the present disclosure preferably has a diameter in a range from 40 mm to 45 mm. In light of satisfying the regulation of US Golf Association (USGA), the diameter is particularly preferably 42.67 mm or more. In light of prevention of air resistance, the diameter is more preferably 44 mm or less, even more preferably 42.80 mm or less. In addition, the golf ball according to the present disclosure preferably has a mass of 40 g or more and 50 g or less. In light of obtaining greater inertia, the mass is more preferably 44.00 g or more, even more preferably 45.00 g or more. In light of satisfying the regulation of USGA, the mass is particularly preferably 45.93 g or less.

When the golf ball according to the present disclosure has a diameter in a range from 40 mm to 45 mm, the compression deformation amount (shrinking amount along the compression direction) of the golf ball when applying a load from 98 N as an initial load to 1275 N as a final load to the golf ball is preferably 2.0 mm or more, more preferably 2.2 mm or more, and is preferably 4.0 mm or less, more preferably 3.5 mm or less. If the compression deformation amount is 2.0 mm or more, the golf ball is not excessively hard and thus the shot feeling thereof is better. On the other hand, if the compression deformation amount is 4.0 mm or less, the resilience is greater.

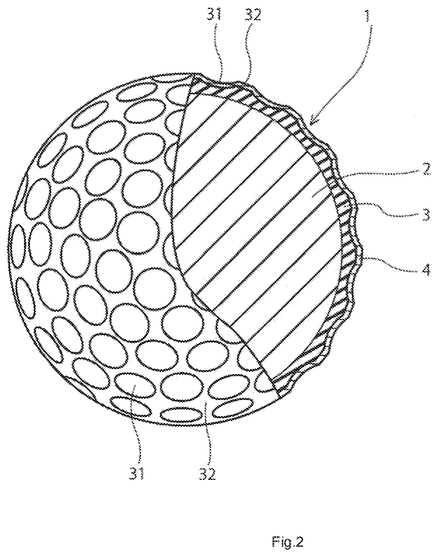

FIG. 2 is a partially cutaway cross-sectional view of a golf ball 1 according to one embodiment of the present disclosure. The golf ball 1 comprises a spherical core 2, a cover 3 covering the spherical core 2, and a paint film 4 formed on a surface of the cover 3. A plurality of dimples 31 are formed on the surface of the cover 3. Other portions than the dimples 31 on the surface of the cover 3 are lands 32.

EXAMPLES

Next, the present disclosure will be described in detail by way of examples. However, the present disclosure is not limited to the examples described below. Various changes and modifications without departing from the spirit of the present disclosure are included in the scope of the present disclosure.

### (1) Slab Hardness (Shore D Hardness)

Sheets with a thickness of about 2 mm were produced by injection molding the intermediate layer composition or cover composition. The sheets were stored at 23° C. for two weeks. At least three of these sheets were stacked on one another so as not to be affected by the measuring substrate on which the sheets were placed, and the hardness of the stack was measured with an automatic hardness tester (Digitest II available from Bareiss company) using a detector of “Shore D”.

### (2) Thickness of Paint Film (μm)

The golf ball was cut into two hemispheres, and the cross section of the paint film on the hemisphere was observed with a microscope (VHX-1000 available from Keyence Corporation) to obtain the thickness of the paint film.

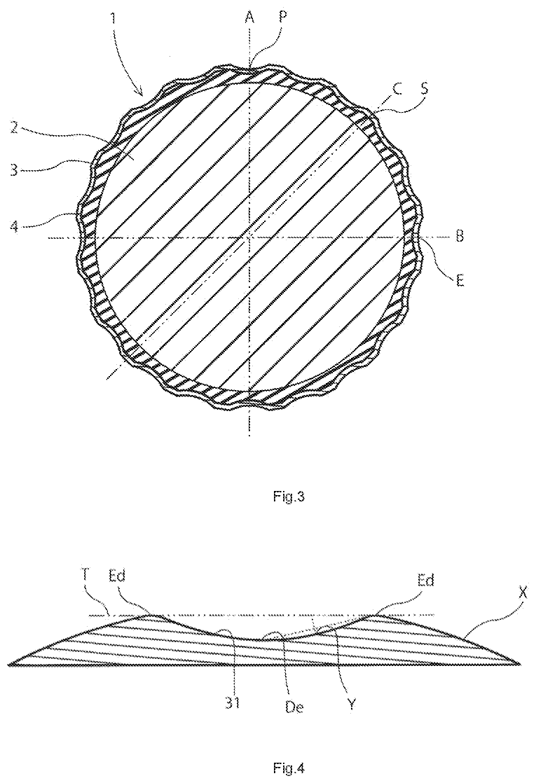

The measuring location of the film thickness will be explained by reference to FIGS. 3 and 4. FIG. 3 is a schematic figure of a cross section of a golf ball. As shown in FIG. 3, on the cross section of the golf ball, a straight line A passing a central point of the ball and a bottom of any dimple, a straight line B perpendicular to the straight line A, and a straight line C having an angle of 45° with the straight line A are prepared, and intersection points of these straight lines with the paint film surface are adopted as a pole P, an equator E and a shoulder S, respectively.

FIG. 4 is a schematic figure of a cross section passing a bottom De of a dimple 31 and a central point of a golf ball 1. The bottom De of the dimple 31 is the deepest location of the dimple 31. An edge Ed is a point of tangency of the dimple 31 with a tangent T, wherein the tangent T is drawn by connecting both sides of the dimple 31. A measuring location Y on an inclined plane is a point at which a perpendicular line intersects with the inclined plane of the dimple, wherein the perpendicular line is drawn from a midpoint of a straight line connecting the bottom De of the dimple and the edge Ed downward to the dimple 31. A measuring location X on a land is a midpoint between edges of adjacent dimples. It is noted that in the case that adjacent dimples contact each other so that no land exists, or in the case that the land is so narrow that the thickness is hard to be measured, the bottom, edge or inclined plane of the dimple is adopted as the measuring point.

In the measurement, test samples were firstly prepared from three locations of six balls, i.e. the dimple where the pole P exists, the dimple near the equator E and the dimple near the shoulder S. Next, regarding each test piece (dimple), the thickness of the paint film at the bottom De, edge Ed, inclined plane Y and land X of the dimple was measured. Finally, measuring values of six balls were averaged, and the obtained average value was adopted as the thickness of the paint film.

### (3) 10% Elastic Modulus of Paint Film

The tensile properties of the paint film were measured according to JIS K7161 (2014). Specifically, the polyisocyanate composition and the polyol composition were blended to prepare a paint, and the obtained paint was dried and cured at 40° C. for 4 hours to prepare a paint film (thickness: 0.05 mm). The paint film was punched into the test piece type H (width of parallel part: 10 mm, gauge length: 50 mm) prescribed in JIS K7127 (1999), to prepare a test piece. The tensile test of the test piece was conducted with a precision universal tester (Autograph (registered trademark) available from Shimadzu Corporation) under testing conditions of a length between grips: 100 mm, a tensile speed: 50 mm/min and a testing temperature: 23° C., and the tensile stress at 10% strain (10% elastic modulus) was recorded.

(4) Spin Rate (rpm) on Driver Shots (W#1)

A driver provided with a titanium head (SRIXON ZX7 available from Sumitomo Rubber Industries, Ltd.) was installed on a swing robot M/C available from True Temper Sports, Inc. The golf ball was hit at a head speed of 50 m/sec, and the spin rate of the golf ball right after the hitting was measured. The measurement was conducted ten times for each golf ball, and the average value thereof was adopted as the measurement value for that golf ball. It is noted that the spin rate of the golf ball right after the hitting was measured by continuously taking a sequence of photographs of the hit golf ball.

(5) Spin Rate (rpm) on Short (8) Iron Shots (I#8)

An 8-iron (SRIXON ZX7 available from Sumitomo Rubber Industries, Ltd) was installed on a swing robot M/C available from Golf Laboratories, Inc. The golf ball was hit at a head speed of 39 m/sec, and the spin rate of the golf ball right after the hitting was measured. The measurement was conducted twelve times for each golf ball, and the average value thereof was adopted as the measurement value for that golf ball. It is noted that the spin rate of the golf ball right after the hitting was measured by continuously taking a sequence of photographs of the hit golf ball.

<Evaluation Standard of Short Iron Spin (rpm)/Driver Spin (rpm)>

G (Good): 3.15 or more

F (Fair): 3,10 or more and less than 3.15

P (Poor): less than 3.10

(6) Spin Rate (rpm) on Long (5) Iron Shots (I#5)

A 5-iron (SRIXON ZX7 available from Sumitomo Rubber Industries, Ltd) was installed on a swing robot M/C available from Golf Laboratories, Inc. The golf ball was hit at a head speed of 41 in/sec, and the spin rate of the golf ball right after the hitting was measured. The measurement was conducted twelve times for each golf ball, and the average value thereof was adopted as the measurement value for that golf ball. It is noted that the spin rate of the golf ball right after the hitting was measured by continuously taking a sequence of photographs of the hit golf ball.

<Evaluation Standard of Long Iron Spin (rpm)/Driver Spin (rpm)>

G (Good): 2.15 or more

F (Fair): 2.10 or more and less than 2.15

P (Poor): less than 2.10

(7) Easiness of Removing Stain from Golf Ball

The easiness of removing stain from the golf ball was measured as follows. The ball was set on grass of the rough. Each ball was hit with a wedge for ten times. Three balls were used for each ball. The ball was wiped with a towel wetted with water, to confirm whether the grass stain was removed.

### <Evaluation Standard>

G (Good): The stain is completely removed when the stain is wiped with the towel wetted with water.

F (Fair): Most of the stain is removed when the stain is wiped with the towel wetted with water, but the stain is found to remain when being observed carefully.

P (Poor): A little of the stain is removed when the stain is wiped with the towel wetted with water, and the stain is found to remain at a glance.

### <Comprehensive Evaluation>

The comprehensive evaluation regarding the short iron spin/driver spin, long iron spin/driver spin and easiness of removing stain was conducted based on the following standard.

A: There is only G in the evaluation results.

B: There is one or more F but there isn't P in the evaluation results.

C: There is one or more P in the evaluation results.

### 1. Production of Spherical Core

According to the formulation shown in Table 1, the rubber composition was kneaded, and heat-pressed at the temperature of 150° C. for 19 mins. in upper and lower molds, each having a hemispherical cavity, to obtain a spherical core having a diameter of 39.7 mm. It is noted that the amount of barium sulfate was adjusted such that the ball had a mass of 45.6 g.

TABLE 1
Core composition

| | | |
|---|---|---|
| Formulation | Polybutadiene | 100 |
| (parts by mass) | Zinc acrylate | 35 |
| | Zinc oxide | 5 |
| | Barium sulfate | Appropriate amount |
| | Diphenyl disulfide | 0.5 |
| | Dicumyl peroxide | 0.9 |

Polybutadiene rubber: “BR730 (high-cis polybutadiene)” available from JSR Corporation

Zinc acrylate: “ZN-DA90S” available from Nisshoku Techno Fine Chemical Co., Ltd.

Zinc oxide: “Ginrei R” available from Toho Zinc Co., Ltd.

Barium sulfate: “Barium Sulfate BD” available from Sakai Chemical Industry Co., Ltd.

Diphenyl disulfide: available from Sumitomo Seika Chemicals Co., Ltd.

Dicumyl peroxide: “Percumyl (register trademark) D” available from NOF Corporation

### 2. Preparation of Intermediate Layer Composition and Cover Composition

According to the formulations shown in Tables 2 and 3, the materials were mixed with a twin-screw kneading extruder to prepare the intermediate layer composition and the cover composition in a pellet form. The extruding conditions were a screw diameter of 45 mm, a screw rotational speed of 200 rpm, and a screw LID=35, and the mixture was heated to 160° C. to 230° C. at the die position of the extruder.

TABLE 2
Intermediate layer composition

| | | |
|---|---|---|
| Formulation | Surlyn 8945 | 55 |
| (parts by mass) | Himilan AM7329 | 45 |
| | Titanium dioxide | 4 |

| | |
|---|---|
| Hardness (Shore D) | 65 |

Himilan (registered trademark) AM7329: zinc ion-neutralized ethylene-methacrylic acid copolymer ionomer resin available from Dow-Mitsui Polychemicals Co., Ltd.

Surlyn 8945: sodium ion-neutralized ethylene-methacrylic acid copolymer ionomer resin available from E.I. du Pont de Nemours and Company

TABLE 3
Cover composition

| | | |
|---|---|---|
| Formulation | Elastollan XNY82A | 100 |
| (parts by mass) | TINUVIN 770 | 0.2 |
| | Titanium dioxide | 4 |
| | Ultramarine blue | 0.04 |

| | |
|---|---|
| Hardness (Shore D) | 29 |

Elastollan XNY82A: thermoplastic polyurethane elastomer available from BASF Japan Ltd.

TINUVIN 770: hindered amine-based light stabilizer available from BASF Japan Ltd.

### 3. Molding of Intermediate Layer

The above obtained intermediate layer composition was directly injection molded on the above obtained spherical core, to form the intermediate layer (thickness: 1.0 mm) covering the spherical core.

### 4. Preparation of Reinforcing Layer

A reinforcing layer composition (trade name “Polin (registered trademark) 750LE” available from Shinto Paint Co. Ltd.) having a two-component curing type epoxy resin as a base resin was prepared. The base material contains 30 parts by mass of a bisphenol A type solid epoxy resin and 70 parts by mass of a solvent. The curing agent contains 40 parts by mass of a modified polyimide amine, 5 parts by mass of titanium dioxide and 55 parts by mass of a solvent. The mass ratio of the base material to the curing agent was 1/1. The reinforcing layer composition was applied to the surface of the intermediate layer with an air gun and kept at an atmosphere of 23 for 12 hours, to form the reinforcing layer. The reinforcing layer had a thickness of 7 μm.

### 5. Molding of Cover

The cover composition in a pellet form was charged into each of the depressed part of the lower mold of a half shell molding mold, and applying a pressure to mold half shells. The spherical body having the reinforcing layer formed thereon was concentrically covered with two of the half shells. The spherical body and half shells were charged into a final mold provided with a plurality of pimples on the cavity surface. The cover (thickness: 0.5 mm) was formed by compression molding, and the golf ball bodies were obtained. A plurality of dimples having an inverted shape of the pimples were formed on the cover.

### 6. Preparation of Paint

### Preparation of Urethane Polyol

According to the formulations shown in Table 4, polytetramethylene ether glycol (PTMG) and trimethylolpropane (TMP) were dissolved as the polyol component in a solvent (toluene and methyl ethyl ketone). Dibutyltin dilaurate was added as a catalyst into the above prepared solution in an amount of 0.1 mass % with respect to 100 mass % of the polyol component. While keeping the temperature of the polyol solution at 80° C., isophorone diisocyanate (IPDI) was added dropwise as the polyisocyanate component to the polyol solution and mixed. After finishing the addition of isophorone diisocyanate, stirring was continued until the isocyanate group disappeared. Then, the reaction liquid was cooled to the room temperature to prepare the urethane polyol (solid component content: 60 mass %),

TABLE 4

| Urethane polyol No. | | 1 |
|---|---|---|
| Material | Number average molecular weight | Molar ratio |
| PTMG 650 | 650 | 1 |
| TMP | 134.2 | 1.87 |
| IPDI | 222.3 | 1.72 |

| | |
|---|---|
| Weight average molecular weight | 7200 |

The following materials were used in the synthesis of the urethane polyol.

PTMG 650: polyoxytetramethylene glycol available from Mitsubishi Chemical Corporation

TMP: trimethylolpropane available from Tokyo Chemical Industry Co:, Ltd.

IPDI: isophorone diisocyanate available from Sumika Covestro Urethane Co., Ltd.

### Preparation of Polyol Compositions

According to the formulations shown in Table 5, the polyrotaxane, polycarbonate diol or urethane polyol was added as the polyol component, and 100 parts by mass of a solvent (a mixed solvent of xylene/methyl ethyl ketone=70/30 (mass ratio)) was mixed with respect to 100 parts by mass of the resin component, to prepare the polyol compositions. It is noted that dibutyltin dilaurate was added as a catalyst in an amount of 0.1 mass % with respect to 100 mass % of the resin component in the polyol composition.

As the polyol component, the following material was used.

Polycarbonate PCD 500 (number average molecular weight: 500, viscosity: 315 mPa·s/50° C.) available from Asahi Kasei Chemicals Corporation

Polyrotaxane: SeRM (registered trademark) super polymer SH₃₄₀₀P (a polyrotaxane having a cyclodextrin, at least a part of hydroxyl groups of the cyclodextrin being modified with a caprolactone chain via a —O—C₃H₆—O— group, a linear molecule of polyethylene glycol, and a blocking group of an adamantyl group; molecular weight of linear molecule: 35,000; hydroxyl value of polyrotaxane: 72 mg KOH/g; total molecular weight of polyrotaxane: 700,000 in weight average molecular weight) available from Advanced Softmaterials Inc.

### Preparation of Polyisocyanate Compositions

According to the formulations shown in Table 5, the polyisocyanates were added to prepare the polyisocyanate compositions.

As the polyisocyanate, the following materials were used.

Isocyanurate-modified product of HDI: isocyanurate-modified product of hexamethylene diisocyanate (Duranate (registered trademark) TKA-100 (NCO amount: 21.7%) available from Asahi Kasei Chemicals Corporation)

Biuret-modified product of HDI: biuret-modified product of hexamethylene diisocyanate (Duranate 21S-75E (NCO amount: 15.5%) available from Asahi Kasei Chemicals Corporation)

Isocyanurate-modified product of IPDI: isocyanurate-modified product of isophorone diisocyanate (VESTANAT (registered trademark) T1890 (NCO amount: 12.0%) available from Degussa Co., Ltd.)

TABLE 5
Formulation of polyol composition and polyisocyanate composition: parts by mass

| Golf ball No. | | | 1 | 2 | 3 | 4 | 5 | 6 | 7 | 8 |
|---|---|---|---|---|---|---|---|---|---|---|
| Polyol | Polycarbonate diol | | — | — | — | — | — | 97 | 97 | 97 |
| composition | Urethane polyol No. 1 | | 100 | 100 | 97 | 97 | 97 | — | — | — |
| | Polyrotaxane | | — | — | 3 | 3 | 3 | 3 | 3 | 3 |
| Polyisocyanate | Isocyanurate-modified product of HDI | | 30 | 30 | 30 | 30 | 30 | 70 | 70 | 70 |
| composition | Biuret-modified product of HDI | | 30 | 30 | 30 | 30 | 30 | — | — | — |
| | Isocyanurate-modified product of IPDI | | 40 | 40 | 40 | 40 | 40 | 30 | 30 | 30 |
| Isocyanate group of polyisocyanate | | | 0.6 | 0.4 | 0.6 | 0.5 | 0.4 | 1.4 | 1.3 | 1.2 |
| composition/hydroxy group of polyol composition | | | | | | | | | | |
| (NCO/OH molar ratio) | | | | | | | | | | |
| 10% Elastic modulus of paint film (kgf/cm²) | | | 65 | 20 | 65 | 40 | 20 | 60 | 40 | 20 |
| Spin | W#1 condition | Spin rate/rpm | 2377 | 2400 | 2342 | 2372 | 2396 | 2332 | 2352 | 2384 |
| performance | I#5 condition | Spin rate/rpm | 5030 | 5100 | 5055 | 5100 | 5134 | 5069 | 5100 | 5149 |
| | I#8 condition | Spin rate/rpm | 7311 | 7153 | 7298 | 7244 | 7300 | 7355 | 7400 | 7439 |

| | | | | | | | | | |
|---|---|---|---|---|---|---|---|---|---|
| | I#5 condition/W#1 condition | 2.12 | 2.13 | 2.16 | 2.15 | 2.14 | 2.17 | 2.17 | 2.16 |
| | | F | F | G | G | F | G | G | G |
| | I#8 condition/W#1 condition | 3.08 | 2.98 | 3.12 | 3.05 | 3.05 | 3.15 | 3.15 | 3.12 |
| | | P | P | F | P | P | G | G | F |
| Stain | Easiness of removing stain | F | P | P | P | P | G | G | G |
| resistance | | | | | | | | | |

| | | | | | | | | |
|---|---|---|---|---|---|---|---|---|
| Comprehensive evaluation | C | C | C | C | C | A | A | B |

### 7. Formation of Paint Film

According to the formulations shown in Table 5, the polyol composition and the polyisocyanate composition were blended to prepare curing type paint compositions. The surface of the golf ball bodies obtained above was treated with sandblast and marked. The paint was applied with a spray gun, and dried for 24 hours in an oven at the temperature of 40° C. to obtain golf balls having a diameter of 42.7 mm and a mass of 45.6 g. The paint film had a thickness of 10±2 μm.

The application of the paint was conducted as follows. The golf ball body was placed in a rotating member provided with prongs, and the rotating member was allowed to rotate at 300 rpm. The application of the paint was conducted by spacing a spray distance (7 cm) between the air gun and the golf ball body, and moving the air gun in an up and down direction. The painting interval in the overpainting operation was set to 1.0 second. The application of the paint was conducted under the spraying conditions of overpainting operation: twice, spraying air pressure: 0.15 MPa, compressed air tank pressure: 0.10 MPa, painting time per one application: one second, atmosphere temperature: 20° C. to 27° C., and atmosphere humidity: 65% or less. Evaluation results regarding the obtained golf balls are shown in Table 6.

It is apparent from Table 5 that the golf ball according to the present disclosure that comprises a golf ball body and a paint film composed of at least one layer and formed on a surface of the golf ball body, wherein an outermost layer of the paint film includes, as a base resin, a polyurethane obtained by a reaction between a polyisocyanate composition and a polyol composition, and the polyol composition contains, as a polyol component, a polyrotaxane having at least two hydroxyl groups and a polycarbonate diol having a number average molecular weight in a range from 400 to 900, has excellent spin performance on short iron shots to long iron shots while maintaining a flight distance on driver shots, and stain such as mud or grass juice can be wiped off therefrom when the golf ball has the stain adhered thereto.

This application is based on Japanese patent application No. 2022-058884 filed on Mar. 31, 2022, the content of which is hereby incorporated by reference.

The golf ball according to the present disclosure (1) is a golf ball comprising a golf ball body and a paint film composed of at least one layer and formed on a surface of the golf ball body, wherein an outermost layer of the paint film includes, as a base resin, a polyurethane obtained by a reaction between a polyisocyanate composition and a polyol composition, and the polyol composition contains, as a polyol component, a polyrotaxane having at least two hydroxyl groups and a polycarbonate diol having a number average molecular weight in a range from 400 to 900.

The golf ball according to the present disclosure (2) is the golf ball according to the present disclosure (1), wherein the polycarbonate diol is a liquid polycarbonate diol.

The golf ball according to the present disclosure (3) is the golf ball according to the present disclosure (1) or (2), wherein an amount of the polyrotaxane in the polyol component is more than 0 mass % and less than 10 mass %.

The golf ball according to the present disclosure (4) is the golf ball according to any one of the present disclosures (1) to (3), wherein the polyrotaxane has a cyclodextrin, a linear molecule piercing through the cyclic structure of the cyclodextrin, and blocking groups located at both terminals of the linear molecule to prevent disassociation of the cyclodextrin, wherein at least a part of hydroxyl groups of the cyclodextrin is modified with a caprolactone chain via a —O—C₃H₆—O— group.

The golf ball according to the present disclosure (5) is the golf ball according to any one of the present disclosures (1) to (4), wherein the polyisocyanate composition contains, as a polyisocyanate component, at least one member selected from the group consisting of an isocyanurate-modified product of hexamethylene diisocyanate, an adduct-modified product of hexamethylene diisocyanate, a biuret-modified product of hexamethylene diisocyanate, and an isocyanurate-modified product of isophorone diisocyanate.

The golf ball according to the present disclosure (6) is the golf ball according to any one of the present disclosures (1) to (5), wherein a molar ratio (NCO/OH) of an isocyanate group included in the polyisocyanate composition to a hydroxyl group included in the polyol composition is 1.0 or more.

The golf ball according to the present disclosure (7) is the golf ball according to any one of the present disclosures (1) to (6), wherein the polyurethane has a 10% elastic modulus of 100 kgf/cm² or less.

1. A golf ball comprising a golf ball body and a paint film composed of at least one layer and formed on a surface of the golf ball body, wherein
an outermost layer of the paint film includes, as a base resin, a polyurethane obtained by a reaction between a polyisocyanate composition and a polyol composition, and the polyol composition contains, as a polyol component, a polyrotaxane having at least two hydroxyl groups and a polycarbonate diol having a number average molecular weight in a range from 400 to 900.

2. The golf ball according to claim 1, wherein the polycarbonate dial is a liquid polycarbonate diol.

3. The golf ball according to claim 1, wherein an amount of the polyrotaxane in the polyol component is more than 0 mass % and less than 10 mass %.

4. The golf ball according to claim 1, wherein the polyrotaxane has a cyclodextrin, a linear molecule piercing through the cyclic structure of the cyclodextrin, and blocking groups located at both terminals of the linear molecule to prevent disassociation of the cyclodextrin, wherein at least a part of hydroxyl groups of the cyclodextrin is modified with a caprolactone chain via a —O—C₃H₆—O— group.

5. The golf ball according to claim 1, wherein the polyisocyanate composition contains, as a polyisocyanate component, at least one member selected from the group consisting of an isocyanurate-modified product of hexamethylene diisocyanate, an adduct-modified product of hexamethylene diisocyanate, a biuret-modified product of hexamethylene diisocyanate, and an isocyanurate-modified product of isophorone diisocyanate.

6. The golf ball according to claim 1, wherein a molar ratio (NCO/OH) of an isocyanate group included in the polyisocyanate composition to a hydroxyl group included in the polyol composition is 1.0 or more.

7. The golf bail according to claim 1, wherein the polyurethane has a 10% elastic modulus of 100 kgf/cm² or less.

8. The golf ball according to claim 1, wherein a molar ratio (NCO/OH) of an isocyanate group included in the polyisocyanate composition to a hydroxyl group included in the polyol composition is 1.2 or more.

9. The golf ball according to claim 2, wherein the polycarbonate diol has a viscosity ranging from 200 mPa·s/50° C. to 2,000 mPa·s/50° C.

10. The golf ball according to claim 1, wherein the polyol component of the polyol composition consists of the polycarbonate diol having the number average molecular weight in the range from 400 to 900 and the polyrotaxane having at least two hydroxyl groups.

11. The golf ball according to claim 1, wherein the polyol component of the polyol composition consists of the polycarbonate diol having the number average molecular weight in the range from 400 to 900 and the polyrotaxane having at least two hydroxyl groups,
an amount of the polyrotaxane in the polyol component is more than 0 mass % and less than 10 mass %,
the polycarbonate dial is a liquid polycarbonate diol having a viscosity ranging from 200 mPa·s/50° C. to 2,000 mPa·s/50° C.,
and a molar ratio (NCO/OH) of an isocyanate group included in the polyisocyanate composition to a hydroxyl group included in the polyol composition is 1.2 or more.
